(19) United States
(12) Patent Application Publication
(10) Pub. No.: US 2023/0206145 A1
(43) Pub. Date: Jun. 29, 2023

(54) LEAD ROUTING SYSTEMS AND METHODS

(71) Applicant: SquareFinch Inc., Kerhonkson, NY (US)

(72) Inventors: Scott MALISH, Kerhonkson, NY (US); Chris SODERMAN, New York, NY (US)

(73) Assignee: SquareFinch Inc., Kerhonkson, NY (US)

(21) Appl. No.: 18/002,100

(22) PCT Filed: Jun. 18, 2021
(86) PCT No.: PCT/US2021/038122

§ 371 Date: Dec. 16, 2022

Related U.S. Application Data
(60) Provisional application No. 63/040,817, filed on Jun. 18, 2020.

(51) Int. Cl. G06Q 10/0631; G06Q 30/02

(52) U.S. Cl. CPC G06Q 10/063112; G06Q 30/0281

(57) ABSTRACT

Disclosed are systems, methods, and computer-readable media for routing leads to account resources. The system comprises a memory and a processor communicatively coupled to the memory. The memory is configured to store leads, lead segments, and account resources. The processor is configured to identify a lead segment to assign a received lead based on an industry, geography, employee count, or persona for the lead. Each lead segment includes a plurality of leads. The processor is further configured to determine a plurality of account resources based on the identified lead segment. Each account resource has a lead quota, an assigned revenue potential, a closing ratio, and an opportunity measure. The processor is further configured to route the lead to an account resource from the plurality of account resources based on the lead quota, the assigned revenue potential, the closing ratio, or the opportunity measure determined for each account resource.

### FIELD OF THE INVENTION

The present invention relates generally to a lead routing system. In particular, the present invention relates to techniques for routing leads on prospective customers to appropriate account resources.

### BACKGROUND OF THE INVENTION

Computer systems, and software applications executing thereon, can perform a variety of different tasks including automation of routing incoming leads. The incoming lead routing can be, for example, in connection with prospective customers or other new leads as part of a business process. Successful growth of enterprises and corporations depends on successful management of new leads. These enterprises may employ account resources such as account executives, sales representatives, sales development representatives, or salespersons to convert a prospect into a committed customer by closing new leads, e.g., making one or more new sales to an incoming lead.

One drawback of conventional software applications used to automate lead routing is that such applications can route leads using business rules, a count-based approach, or a weighting-based approach. For example, a conventional count-based approach assigns received leads such that each account resource receives an equal number of leads. A conventional weighting-based approach assigns received leads such that each account resource receives a weighted percentage of leads. Such conventional applications are limited their ability to increase sales achievement opportunities for enterprises.

### SUMMARY OF THE INVENTION

The subject disclosure provides a computer system for routing a lead to an account resource. The system includes a memory and a processor communicatively coupled to the memory. The memory is configured to store leads, lead segments, and account resources. The processor is configured to identify a lead segment to assign a received lead based on an industry, geography, employee count, or persona for the lead. Each lead segment includes a plurality of leads. The processor is further configured to determine a plurality of account resources based on the identified lead segment. Each account resource has a lead quota, an assigned revenue potential, a closing ratio, and an opportunity measure. The processor is further configured to route the lead to an account resource from the plurality of account resources based on the lead quota, the assigned revenue potential, the closing ratio, or the opportunity measure determined for each account resource in the plurality of account resources.

In some aspects, the processor configured to route the lead to the account resource is further configured to determine the account resource for receiving the routed lead based on determining a percentage of the assigned revenue potential relative to the lead quota. The account resource can be determined based on comparing the percentages of the assigned revenue potential among the plurality of account resources, and identifying the account resource having the lowest percentage of assigned revenue potential to receive the routed lead. The processor configured to route the lead to the account resource can be further configured to determine the account resource for receiving the routed lead based on the closing ratio for each account resource among the plurality of account resources determined based on the identified lead segment. The account resource can be determined based on identifying the account resource having a maximum closing ratio among the plurality of account resources associated with the identified lead segment to receive the routed lead. The processor configured to route the lead to the account resource can be further configured to determine the account resource for receiving the routed lead based on the closing ratio, the opportunity measure, and a percentage of the assigned revenue potential determined relative to the lead quota. The opportunity measure can include an opportunity maximum, and the account resource can be determined based on comparing the percentages of assigned revenue potential among the plurality of account resources, and identifying the account resource having a lowest percentage of assigned revenue potential while satisfying a minimum closing ratio and the opportunity maximum to receive the routed lead. The received lead can have a revenue potential. The lead quota can be determined based on a revenue target associated with the account resource to be achieved in a predetermined time period.

In another exemplary embodiment, the subject disclosure provides a computer-implemented method of routing a lead to an account resource. The method includes identifying, using a computer, a lead segment to assign a received lead based on an industry, geography, employee count, or persona for the lead. Each lead segment includes a plurality of leads. The method further includes determining, using the computer, a plurality of account resources based on the identified lead segment. Each account resource has a lead quota, an assigned revenue potential, a closing ratio, and an opportunity measure. The method further includes routing, using the computer, the lead to an account resource from the plurality of account resources based on the lead quota, the assigned revenue potential, the closing ratio, or the opportunity measure determined for each account resource in the plurality of account resources.

In some aspects, the routing the lead to the account resource further includes determining the account resource for receiving the routed lead based on determining a percentage of the assigned revenue potential relative to the lead quota. The routing the lead to the account resource can further include determining the account resource for receiving the routed lead based on the closing ratio for each account resource among the plurality of account resources determined based on the identified lead segment. The routing the lead to the account resource can further include determining the account resource for receiving the routed lead based on the closing ratio, the opportunity measure, and a percentage of the assigned revenue potential determined relative to the lead quota. The closing ratio can be determined based on a count of leads routed to an account resource relative to a count of leads closed by the account resource. The closing ratio can be further determined based on a predetermined time window.

In another exemplary embodiment, the subject disclosure provides a non-transitory computer-readable medium having instructions stored therein which upon execution cause a processor to identify a lead segment to assign a received lead based on an industry, geography, employee count, or persona for the lead. Each lead segment includes a plurality of leads. The instructions upon execution cause the processor to determine a plurality of account resources based on the identified lead segment. Each account resource has a lead quota, an assigned revenue potential, a closing ratio, and an opportunity measure. The instructions upon execution cause the processor to route the lead to an account resource from the plurality of account resources based on the lead quota, the assigned revenue potential, the closing ratio, or the opportunity measure determined for each account resource in the plurality of account resources.

In some aspects, the instructions which upon execution cause the processor to route the lead to the account resource further include instructions which upon execution cause the processor to determine the account resource for receiving the routed lead based on determining a percentage of the assigned revenue potential relative to the lead quota. The instructions which upon execution cause the processor to route the lead to the account resource can further include instructions which upon execution cause the processor to determine the account resource for receiving the routed lead based on the closing ratio for each account resource among the plurality of account resources determined based on the identified lead segment. The instructions which upon execution cause the processor to route the lead to the account resource can further include instructions which upon execution cause the processor to determine the account resource for receiving the routed lead based on the closing ratio, the opportunity measure, and a percentage of the assigned revenue potential determined relative to the lead quota. The lead can have a revenue potential, a win rate, an average sales price, and a target conversion rate, and the revenue potential can be determined based on multiplying the win rate by the average sales price and by the target conversion rate. The win rate can be determined based on determining a likelihood of winning an opportunity after the opportunity has been qualified, the opportunity can be based on a lead after the lead has been qualified, and the lead can be qualified by an account resource based on a determination of a likelihood of the lead generating revenue if the lead is pursued. The average sales price can be determined based on the lead or the identified lead segment. The target conversion rate can be determined based on a likelihood of qualifying the lead into an opportunity to generate revenue.

### BRIEF DESCRIPTION OF THE DRAWINGS

The foregoing summary, as well as the following detailed description of the exemplary embodiments of the invention, will be better understood when read in conjunction with the appended drawings. For purposes of illustrating the invention, the drawings illustrate embodiments that are presently preferred. It should be understood, however, that the invention is not limited to the precise arrangements and instrumentalities shown.

In the drawings:

FIG. 1 illustrates a system in which techniques for lead routing are employed, in accordance with exemplary embodiments;

FIGS. 2-5 illustrate screenshots of a user interface of the present lead routing systems, in accordance with exemplary embodiments;

FIG. 6 is a flowchart of a method suitable for lead routing, in accordance with exemplary embodiments;

FIGS. 7-9 are process overview diagrams of techniques for lead routing, in accordance with exemplary embodiments;

FIGS. 10A-10B are diagrams of data structures for lead routing, in accordance with exemplary embodiments; and

FIG. 11 is a block diagram of a computer system for lead routing, in accordance with exemplary embodiments.

### DETAILED DESCRIPTION OF THE DRAWINGS

Reference will now be made in detail to the various embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. For example, the term “a,” as used in the specification, means “at least one.” The terminology includes the words above specifically mentioned, derivatives thereof, and words of similar import.

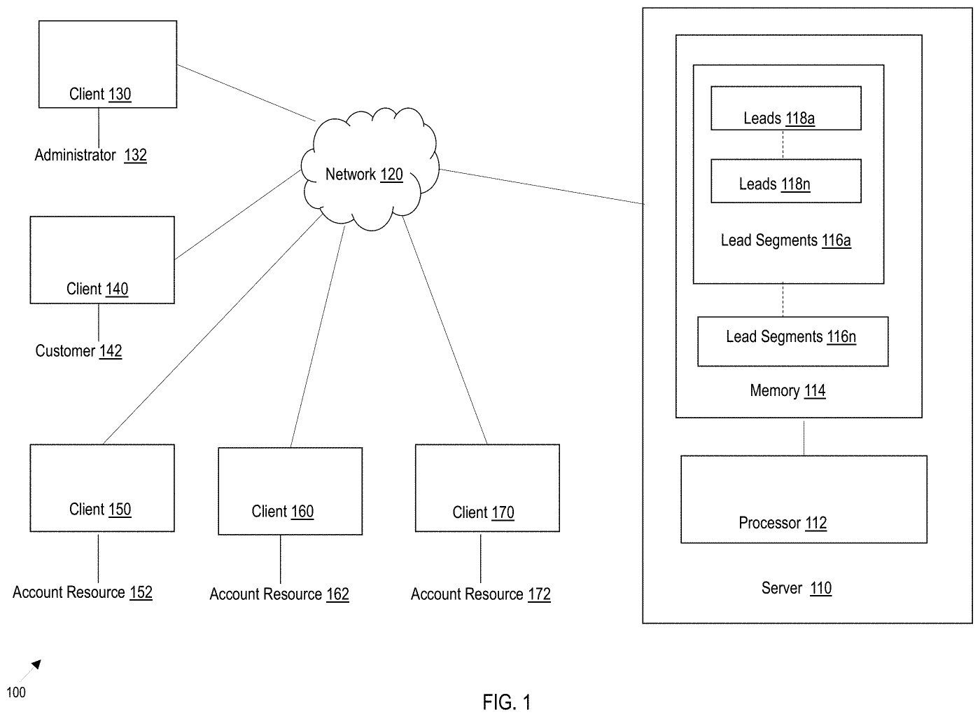

Referring now to FIG. 1, a system 100 is shown that is suitable for lead routing in accordance with exemplary embodiments. The system includes a memory 114 and a processor 112. The memory is configured to store leads, lead segments, and account resources, as described in further detail below. The processor is communicatively coupled to the memory and configured for lead routing, also as described in further detail below.

A technical problem associated with conventional lead routing systems is low performance and accuracy when routing incoming leads to account resources. For example, inflexible conventional business rules, conventional count-based approaches, or conventional weighting-based approaches all route received leads to account resources in an unoptimized manner. For example, a conventional count-based approach assigns an equal number of leads to each account resource, but the assignments can include received leads that are outside the assigned account resource's familiarity. A conventional weighting-based approach assigns a weighted percentage of received leads to account resources, but such approach still fails to account for need-based metrics or performance-based metrics for routing leads to account resources.

A technical solution provided by the present lead routing systems and methods to address the above technical problem includes improving performance and accuracy of lead routing. The improved performance and accuracy can thereby allow the present lead routing systems and methods to handle lead routing at large scales, for example by accounting for need-based metrics and/or performance-based metrics when routing received leads to account resources.

The system 100 includes one or more client computers 130, 140, 150, 160, 170 communicatively coupled to a server computer 110 over a network 120. The client 130 is a computer employed by a user such as an application administrator 132 of a company to operate lead routing functionality of the present system such as on the server. The application administrator can also be referred to as a sales operations administrator or an app administrator. The sales operations administrator can be, for example, a sales operations manager. The client 140 is a computer employed by a prospective customer 142 such as a business prospect representing an input lead. For example, the client 140 can display a user interface for entering metadata indicating interest in or relating to a new sales opportunity or relationship with a new company or enterprise. The clients 150, 160, 170 are computers employed by account resources 152, 162, 172 and include a user interface for receiving leads routed by the present system, such as from the server. The account resources can be, for example, account executives, sales representatives, salespeople, or the like for a particular company. In one example, the application administrator can cause the server to execute a computer-implemented process configured to route leads received from the prospective customer to the most effective or appropriate account resource among one or more account resources 152, 162, 172, so as to maximize revenue potential among the company overall and for the received lead.

The system 100 includes the server computer 110 having a processor 112 coupled to a memory 114. The memory 114 can be any data storage device configured to store lead segments 116a-n where each lead segment includes leads 118a-118n. For example, the memory can include a random access memory, a non-transitory storage having a computer-readable medium, or a persistent store such as a database.

The processor 112 is configured to identify a lead segment from lead segments 116a-n and to assign a received lead from leads 118a-n.

As used herein, the leads 118a-n refer to business prospects to be routed or assigned to an account resource. The present system is configured to qualify received leads so as to determine a likelihood of completion or closing for a prospective sale. As used herein, lead qualification refers to a process by which an account resource determines whether a chance exists for revenue generation by pursuing the lead. The leads can have parameters including, for example, an industry, a geography, an employee count, a persona, or other parameters that are associated with the lead. These parameters are discussed in further detail below.

As used herein, a lead segment 116a-n refers to a grouping that includes one or more leads. Non-limiting example lead segments include Business-to-business (B2B) Tech Small Businesses, B2B Tech Medium Businesses, and B2B Tech Large Businesses. The present system 100 can determine a lead segment dynamically based on one or more parameters. For example, the present system can determine the leads for inclusion in a specified lead segment based on parameters such as, for example, the industry, geography, employee count, or persona for a specified lead. Alternatively, the present system can determine the lead segment statically based on a user configuration determined by, for example, the application administrator. For example, the application administrator can create business rules or other configuration indicating the market share boundaries for a lead to be grouped into a lead segment tracking “Small,” “Medium,” or “Large” Businesses. In some aspects, the present system is configured to determine the account resource to receive a routed lead based on the leads included in a corresponding lead segment, as described in further detail below.

The processor 112 is further configured to determine one or more account resources such as the account resources 152, 162, 172 based on an identified lead segment. As used herein, an account resource refers to an account executive, sales representative, sales development representative, or salesperson who will receive a work assignment corresponding to a received lead. In some aspects, the account resource can be an individual. Alternatively, the account resource can be a team. An account resource can include one or more parameters including a lead quota, an assigned revenue potential, a closing ratio, and an opportunity measure. These parameters are described in further detail below.

The processor 112 is further configured to route the received lead to an account resource from the one or more account resources. The lead routing represents an assignment of the received lead to an account resource. The lead routing is determined based on the lead quota, assigned revenue potential, closing ratio, or opportunity measure determined for each account resource in the plurality of account resources, as described in further detail below.

The server 110 and the clients 130, 140, 150, 160, 170 can comprise any hardware and software techniques, or a combination of hardware and software, for executing computer-implemented instructions in accordance with the present lead routing techniques described herein. The servers and clients can be any user communication device suitable for performing the lead routing techniques described herein. In some aspects, the user communication device can be a desktop computer, a laptop computer, a smartphone, tablet, or other mobile device configured to have access to a network, such as the internet, via a web browser application or an application programming interface (API) so as to be able to connect and communicate with the server via a website or application hosted by the server.

The network 120 can comprise any hardware and software techniques, or combination, for executing computer-implemented instructions for lead routing, including communicating with electronic devices such as server 110 and clients 130, 140, 150, 160, 170 in accordance with the present techniques. In some aspects, the network is a communication network such as the internet. In some aspects, the network is a communication network such as a single network or a combination of networks, including parts of an Ethernet, LAN, WAN, WiFi, or WiMax network, a wireless network, an optical network, a cellular network, a global network, a Public Switch Telephone Network (PTSN), or a fiber optic network.

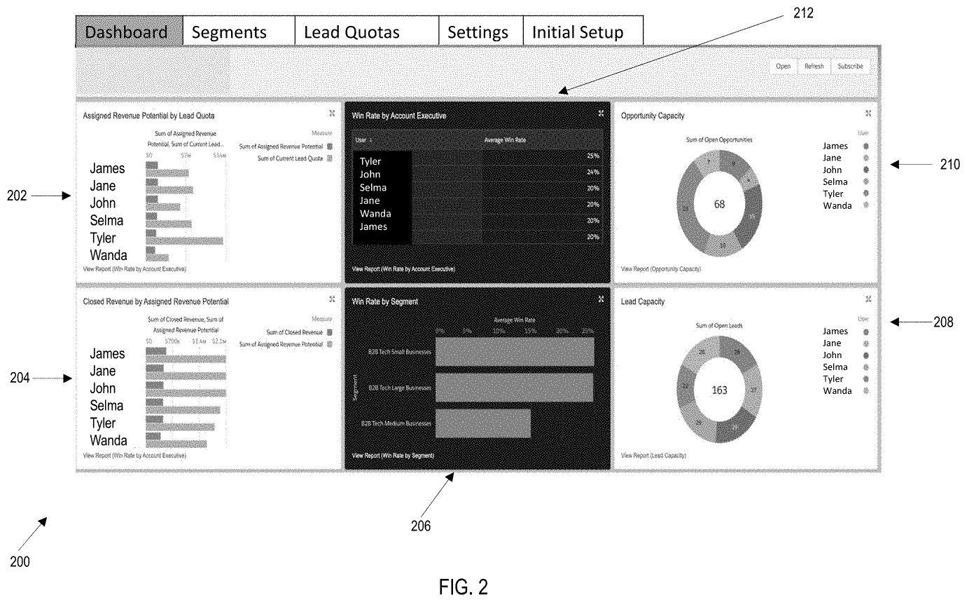

FIGS. 2-5 illustrate screenshots of a user interface of the present lead routing systems and methods, in accordance with exemplary embodiments.

Turning to FIG. 2, shown is a screen shot 200 of a user interface for lead routing techniques in accordance with exemplary embodiments. The screen shot includes an example dashboard displayed in a graphical user interface (GUI) generated by the present system (e.g., by the server).

The screen shot 200 includes a section 202 displaying assigned revenue potential by lead quota per account resource. As used herein, “assigned revenue potential” refers to a measure of accrued revenue potential value of all leads assigned to the account resource. The present system is configured to determine the assigned revenue potential for a specified account resource based on the accrued revenue potential for the leads that are assigned to the account resource. As used herein, “revenue potential” refers to a measure of potential revenue that a specified lead has available to generate. In some aspects, the revenue potential can be user-specified. In further aspects, the present system is configured to determine the revenue potential for a specified lead dynamically according to the following calculation: win rate multiplied by average sales price multiplied by conversion rate. As used herein, the “win rate” measures a likelihood of the account resource winning a sales opportunity after the lead has been qualified. In one example, assume that the win rate is 10%, the average sales price is $500, and the conversion rate is 80%. Therefore, in this example, the revenue potential for the specified lead is determined to be $40=(10%×$500×80%). As discussed above, the present system determines the sales opportunity to exist after the lead has been qualified. The present system allows for a lead to be qualified by an account resource based on determining a likelihood of the lead to generate revenue if the lead is pursued. The present system determines the average sales price as the average or mean sales price for a specific type of lead or lead segment. The present system determines the conversion rate for the lead based on determining a likelihood of qualifying the lead into a sales opportunity to generate revenue. The conversion rate is sometimes referred to herein as target conversion rate.

The screen shot 200 also includes a section 204 displaying closed revenue relative to revenue potential, for a specified account resource. As used herein, “closed revenue” refers to revenue associated with a lead that has been closed, e.g., the account resource has successfully converted the prospective customer into an actual customer having an associated sales opportunity.

The screen shot 200 also includes a section 206 displaying win rate per lead segment and a section 212 displaying win rate per account resource. As discussed above, the present system determines the win rate by determining a likelihood of winning a sales opportunity after the sales opportunity has been qualified from being a lead. The section 206 displays win rates for three corresponding exemplary lead segments. The displayed lead segments are B2B Tech Small Business, B2B Tech Medium Business, and B2B Tech Large Business. The section 212 displays win rates for six corresponding exemplary account resources. The displayed account resources are Tyler, John, Selma, Jane, Wanda, and James.

The screen shot 200 includes a section 208 showing lead capacity and a section 210 displaying opportunity capacity. As used herein, lead capacity refers to a measure or count of open leads that have not been closed. In this example, the section 208 displays a circle graph of lead capacity for exemplary account resources including James, Jane, John, Selma, Tyler, and Wanda. As used herein, opportunity capacity refers to a measure or count of open opportunities that have not been closed. The section 210 displays a circle graph of opportunity capacity for these exemplary account resources.

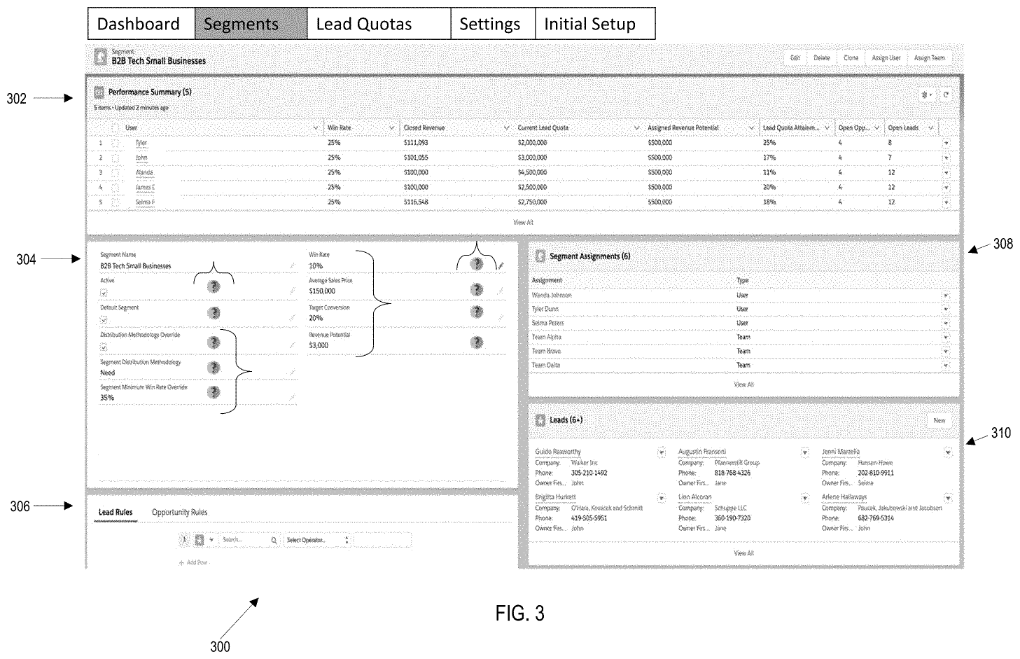

Turning to FIG. 3, shown is a screen shot 300 of a user interface for lead routing techniques in accordance with exemplary embodiments. The screen shot includes an example lead segment configuration screen displayed in a GUI generated by the present system.

The screen shot 300 includes a section 302 displaying performance information associated with account resources. As shown in the section, the performance information includes win rate, closed revenue, current lead quota, assigned revenue potential, lead quota attainment, open opportunities, and open leads. The present lead routing system is configured to execute a lead qualification process to allow an account resource to determine if there is a chance to generate revenue by pursuing a lead, as described in further detail below. The present lead routing system is also configured to execute a lead conversion process to allow an account resource to convert a lead into an opportunity. Open opportunities refer to sales opportunities that have not yet been closed. Open leads refer to leads that have not yet been converted to sales opportunities.

The diagram 300 also includes a section 304 allowing an application administrator to configure metadata for a specified lead segment. For a specified example lead segment such as B2B Tech Small Businesses, the section 304 allows the application administrator to configure parameters for the lead segment including, for example, the lead segment name, whether the lead segment is active, whether the lead segment is the default segment, whether the distribution methodology should be overridden, the distribution methodology to be used for leads grouped into the specified lead segment, whether the minimum win rate should be overridden, the win rate, the average sales price, the conversion rate, and the revenue potential for the lead segment.

The screen shot 300 also includes a section 306 that allows selection by the application administrator of lead rules and opportunity rules for execution. In some aspects, the lead rules and the opportunity rules comprise business rules and criteria for specifying conditions under which leads can be considered to convert to opportunities.

The screen shot 300 also includes a section 308 allowing the application administrator to display assignments of received leads to account resources. In some aspects, the present system routes or assigns leads to individual account resources. In other aspects, the present system is configured to route or assign leads to groups of account resources such as teams. In this example, section 308 displays six lead segment assignments.

The screen shot 300 also includes a section 310 that allows the application administrator to configure parameters and metadata associated with leads. For example, configurable parameters include the associated company, an associated phone number, and associated owner information such as a first name. For example, section 310 displays contact information for points of contact associated with six example leads, including Guido Raxworthy, Augustin Fransoni, Jenni Marzella, Brigitta Hurkett, Lion Alcoran, and Arlene Hallaways. The example leads have been received from respective companies including Walker Inc., Plannerstill Group, Hansen-Howe, O'Hara, Kovacek and Schmitt, Schuppe LLC, and Paucek, Jakubowski and Jacobson.

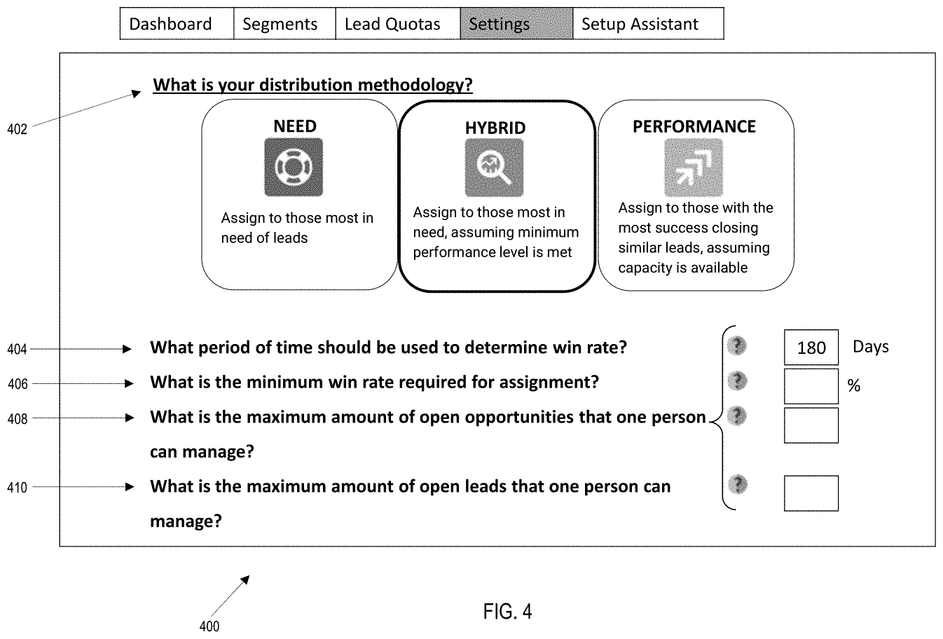

Turning to FIG. 4, shown is a screen shot 400 of a user interface for lead routing techniques in accordance with exemplary embodiments. The screen shot 400 includes an example distribution method settings screen displayed in a GUI generated by the present system.

The screen shot 400 includes a section 402 to allow an application administrator to select and configure different distribution methods. As used herein, “distribution methods” refer to lead routing techniques for routing received leads to account resources. The present system provides three embodiments of lead routing processes: a need-based process, a performance-based process, and a hybrid process. These lead routing processes are described in further detail below. The present system is configured to execute a lead routing process including routing a received lead to an account resource based on the lead quota, assigned revenue potential, closing ratio, or opportunity measure determined for each account resource in a plurality of account resources associated with an identified lead segment.

The need-based process is configured to route or assign received leads to account resources that the present system determines to need leads. In one aspect, the need-based process identifies an account resource to receive an incoming lead based on determining a percentage of assigned revenue potential for the account resource relative to a lead quota for the account resource. As used herein, the “lead quota” refers to a revenue target that an account resource is responsible for achieving in a specified time period. In a further aspect, the need-based process further includes identifying the account resource among the plurality of account resources based on determining the account resource having a lowest percentage of assigned revenue potential relative to lead quota. The present system is configured to determine the lead quota based on determining a revenue target associated with the account resource to be achieved in a pre-determined time period.

The performance-based process is configured to route or assign received leads to account resources that the present system determines to be high performers. In one aspect, the performance-based process identifies an account resource to receive an incoming lead based on a closing ratio that is determined for each account resource associated with each lead belonging to the lead segment into which the incoming lead is allocated. As used herein, a “closing ratio” refers to a ratio of assigned revenue potential associated with the revenue generated by a specified account resource. For example, the closing ratio can be calculated as a ratio of a count of leads assigned to the specified account resource, compared to a count of sales opportunities closed by the specified account resource. In some aspects, the closing ratio can have an associated assessment window representing the number of historical days to be evaluated for purposes of the performance-based process. In further aspects, the performance-based process can require a minimum closing ratio that represents the lowest closing ratio that an account resource is required to have closed so as to be eligible to receive the incoming lead. In a yet further aspect, the performance-based process further includes identifying the account resource based on determining a maximum closing ratio among each account resource associated with each lead belonging to the lead segment into which the incoming lead is allocated.

The hybrid process is configured to route or assign received leads to account resources that the present system determines in accordance with a combination of need-based metrics and performance-based metrics. In one aspect, the hybrid process identifies an account resource to receive an incoming lead based on identifying the account resource having the most success in closing similar leads (e.g., in accordance with performance-based metrics), while also ensuring that the identified account resource has capacity available, for example relative to a closing ratio or an opportunity measure (e.g., in accordance with satisfying need-based metrics or guardrails). In a further aspect, the hybrid process identifies the account resource based on determining a percentage of assigned revenue potential for the account resource relative to the lead quota for the account resource, while also meeting a determined minimum closing ratio for the account resource and identifying an account resource who satisfies the opportunity measure. A non-limiting example opportunity measure includes determining that the identified account resource remains below a determined opportunity maximum after receiving the input lead. In a still further aspect, the hybrid process further includes determining the account resource based on identifying the account resource having a lowest percentage of assigned revenue potential for the account resource relative to the lead quota for the account resource while meeting the determined minimum closing ratio for the account resource and identifying the account resource that satisfies the determined opportunity measure (e.g., determined that the identified account resource will remain below a determined opportunity maximum after receiving the input lead).

The screen shot 400 further includes a field 404 that allows user configuration of a desired time period or window for determining the win rate. The screen shot further includes a field 406 that allows user configuration of the minimum win rate for use in lead routing, as discussed above. The screen shot 400 further includes a field 408 that allows user configuration of the maximum amount or count of open opportunities that an account resource can manage. The screen shot 400 further includes a field 410 that allows user configuration of the maximum amount or count of open leads that the account resource can manage.

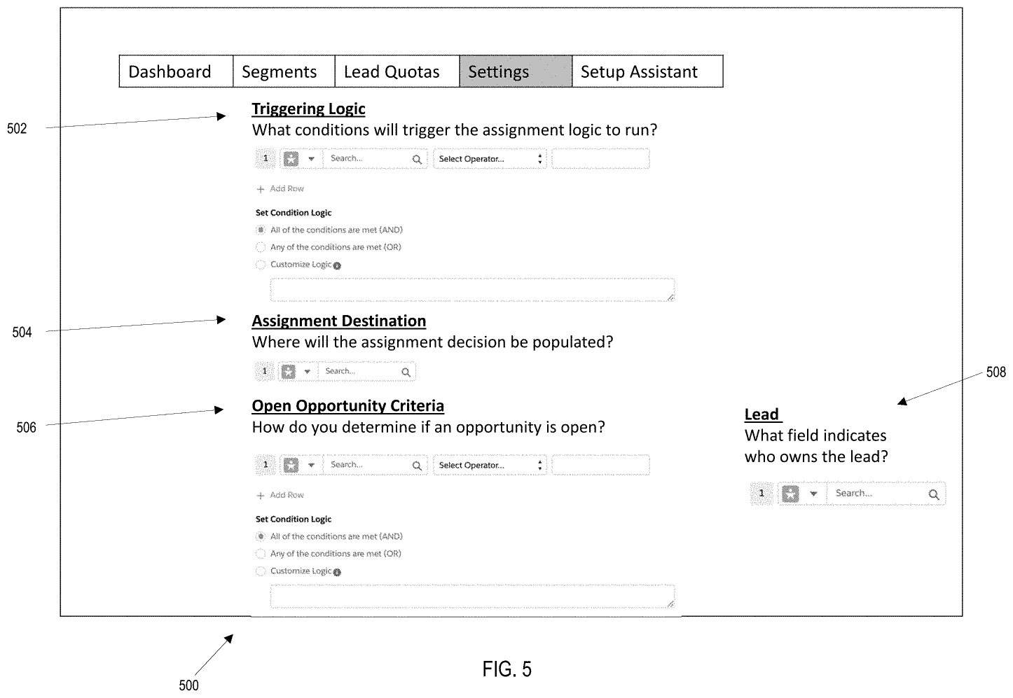

Turning to FIG. 5, shown is a screen shot 500 of a user interface for lead routing techniques, in accordance with exemplary embodiments. The screen shot further illustrates an example distribution method settings screen displayed in a GUI generated by the present system.

The screen shot 500 includes a field 502 that allows configuration of triggering logic to provide conditions that will trigger the lead routing or lead assignment logic process. The present system allows the user, e.g., an application administrator, to define and configure business rules that may be defined as rules and criteria for specifying conditions that a received lead must meet so as to be grouped or matched into a lead segment. The present system allows an application administrator to define lead routing or lead assignment logic. In some aspects, the lead assignment logic can include conditional logic for lead segment rules that define how incoming leads are grouped dynamically or statically into the lead segments. For example, if there are three rules denoted A, B, C, then the conditional logic can include boolean operators (e.g., and, or, xor, not), such as “(A and B) or C.”

The screen shot 500 also includes a field 504 that allows configuration of lead route or lead assignment destination information related to customizing lead assignment destinations. By way of non-limiting example, this field allows the application administrator to configure lead or lead owner parameters for use with persistent storage, such as customizing the user ID field used in connection with the company's leads and lead owners.

The screen shot 500 further includes a field 506 that allows configuration of open opportunity criteria to allow customization of criteria for determination of whether a sales opportunity is considered open. The present system uses the pre-determined open opportunity criteria in connection with the opportunity measure described above. For example, the present system uses the open opportunity criteria in determining the opportunity measure, such as determining whether a potential account resource has exceeded the opportunity maximum and therefore should be considered ineligible for receiving an incoming lead in connection with the distribution processes described above (e.g., the performance-based process or the hybrid process).

The screen shot 500 additionally includes a field 508 that allows configuration of lead ownership information relating to ownership of leads. By way of non-limiting example, this field allows the application administrator to configure account resource parameters in connection with persistent storage, such as customizing the database field used to denote the person who owns a received lead.

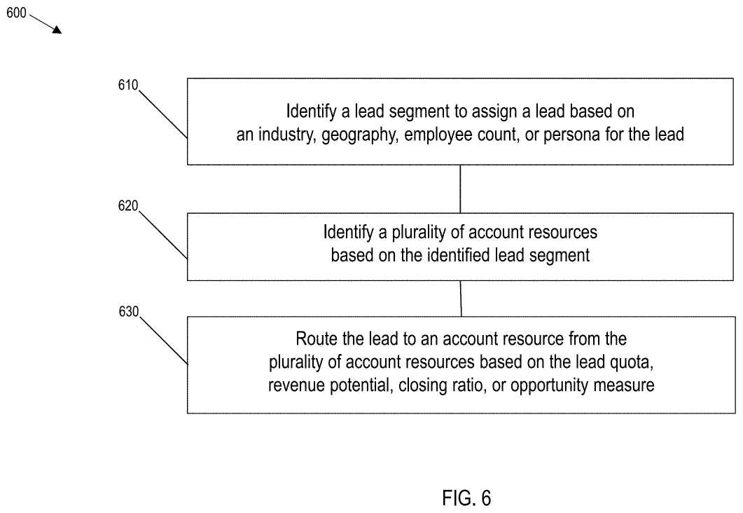

Referring to FIG. 6, a flowchart 600 is shown of a lead routing method in accordance with exemplary embodiments. To illustrate operation, the computer-implemented lead routing method is performed by the processor associated with the server of the present system.

The present system identifies a lead segment to assign a received lead based on an industry, a geography, an employee count, or a persona for the lead (step 610). Alternatively, the present system identifies the lead segment based on a combination of the parameters, or any other suitable parameter or field associated with the received lead. Each lead segment can include one or more leads, as discussed above. For example, the present system can determine based on an industry for a received lead that the lead matches into a lead segment for Restaurants. The present system can determine based on a geography for the received lead that the lead matches into a lead segment for Mid-Atlantic Businesses. The present system can determine based on an employee count for the received lead that the lead matches into a lead segment for Small, Medium, or Large Businesses. The present system can determine based on a persona for the received lead that the lead matches into a lead segment for business-to-business (B2B) Technology. In some aspects, the received lead can be associated with a revenue potential.

The present system determines one or more account resources based on the identified lead segment (step 620). Each account resource has a lead quota, an assigned revenue potential, a closing ratio, and an opportunity measure. The closing ratio can be determined based on a count of leads routed to an account resource relative to a count of leads closed by the account resource. The closing ratio can be further determined based on a predetermined time window. For example, if the present system has identified a Restaurants lead segment to assign a received lead, and the Restaurants lead segment contains a Mariachi restaurant lead and a Lai Thai restaurant lead that are each assigned to account resource Alice, a Pho restaurant lead and a Hoagie restaurant lead that are each assigned to account resource Bob, and a Southern Kitchen restaurant lead and a Bagel Shop restaurant lead that are each assigned to account resource Carl, then the determined account resources would include Alice, Bob, and Carl.

The present system routes the lead to an account resource from the plurality of account resources based on the lead quota, assigned revenue potential, closing ratio, or opportunity measure determined for each account resource in the plurality of account resources (step 630). The routing the lead to the account resource can include determining the account resource for receiving the routed lead based on a percentage of the assigned revenue potential relative to the lead quota. For example, the determining the account resource based on the percentage of assigned revenue potential can include comparing the percentages of assigned revenue potential among the plurality of account resources, and identifying the account resource having the lowest percentage of assigned revenue potential to receive the routed lead. This need-based distribution method is described in further detail below.

Alternatively, the routing the lead to the account resource can include determining the account resource for receiving the routed lead based on the closing ratio for each account resource among the plurality of account resources determined based on the identified lead segment. For example, the determining the account resource based on the closing ratio can include identifying the account resource having a maximum closing ratio among the plurality of account resources associated with the identified lead segment. This performance-based distribution method is described in further detail below.

Alternatively, the routing the lead to the account resource can include determining the account resource for receiving the routed lead based on a percentage of the assigned revenue potential, a closing ratio, and an opportunity measure. For example, the opportunity measure can be an opportunity maximum. The determining the account resource based on the percentage of assigned revenue potential, the closing ratio, and the opportunity measure can include comparing the percentages of assigned revenue potential among the plurality of account resources, and identifying the account resource having the lowest percentage of assigned revenue potential while satisfying a minimum closing ratio and the opportunity maximum to receive the routed lead. This hybrid distribution method is described in further detail below.

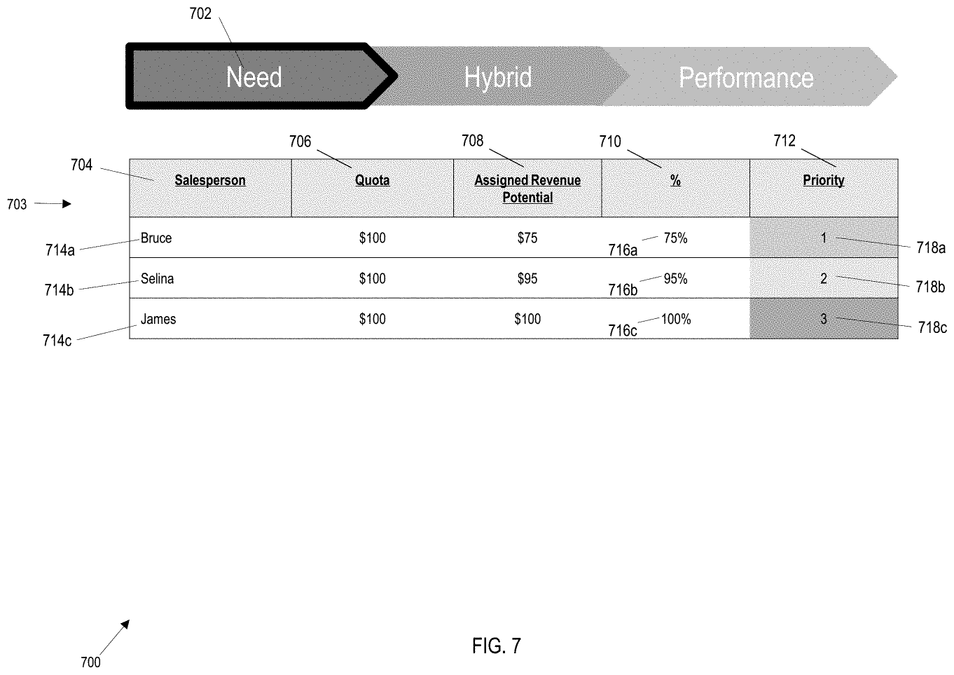

Referring now to FIGS. 7-9, shown are process overview diagrams 700-900 of lead routing techniques, in accordance with exemplary embodiments.

Turning to FIG. 7, shown is a process overview diagram 700 of a need-based lead routing technique, in accordance with exemplary embodiments.

The process overview diagram 700 includes an example screen shot of an outcome of a need-based lead routing process 702. The diagram can be displayed in a GUI generated by the present system. The generated GUI can include, for example, markup language such as hypertext markup language (HTML) that the server computer of the present system generates for display in a web browser. The diagram includes a table 703 with a column 704 labeled “Salesperson” that lists names of three account resources listed as Bruce, Selina, and James. The table also includes a column 706 labeled “Assigned Revenue Potential” that represents the assigned revenue potential associated with each account resource. The table also includes a column 708 labeled “Lead Quota” that represents the lead quota associated with each account resource. The table also includes a column 710 labeled “%” that represents a percentage based on the assigned revenue potential relative to the lead quota associated with each account resource. Finally, the table includes a column 712 labeled “Priority” that represents the relative priority associated with a specified account resource that represents a ranked preference that a received lead is to be routed to a specified account resource relative to another account resource.

The need-based lead routing process (sometimes also referred to herein as a need-based distribution process) is configured to determine the account resource for receiving the routed lead based on a percentage of the assigned revenue potential relative to the lead quota. In some aspects, the need-based process is configured to compare assigned revenue potential percentages among the account resources that are identified as available in connection with the received lead. In further aspects, the need-based process identifies the account resource having the lowest assigned revenue potential percentage relative to the lead quota among the plurality of account resources. By way of example and not limitation, the relevant account resources 714a, 714b, 714c include Bruce, Selina, and James. The present system determines the assigned revenue potential percentages 716a, 716b, 716c based on comparing the assigned revenue potential 706 for the account resource with the corresponding lead quota 708 for the account resource. For example, the present system determines the relevant assigned revenue potential percentages 710 to include 75% (=$75/$100) for Bruce relative to his lead quota, 95% (=$95/$100) for Selina relative to her lead quota, and 100% (=$100/$100) for James relative to his lead quota. Based on the assigned revenue potential percentages relative to the lead quotas for the account resources, the present system determines that account resource Bruce is associated with the lowest assigned revenue potential percentage and therefore assigns Bruce with the highest priority 718a labeled as “1”. In contrast, account resource Selina is associated with a lower priority 718b labeled as “2” and account resource James is associated with a still lower priority 718c labeled as “3.” Accordingly, the present system is configured to route the next received lead to account resource Bruce since he is associated with the highest need-based priority. It will be noted that the need-based process is configured to operate regardless of the lead segment associated with the received lead, and regardless of the account resource's historical performance with other similar leads.

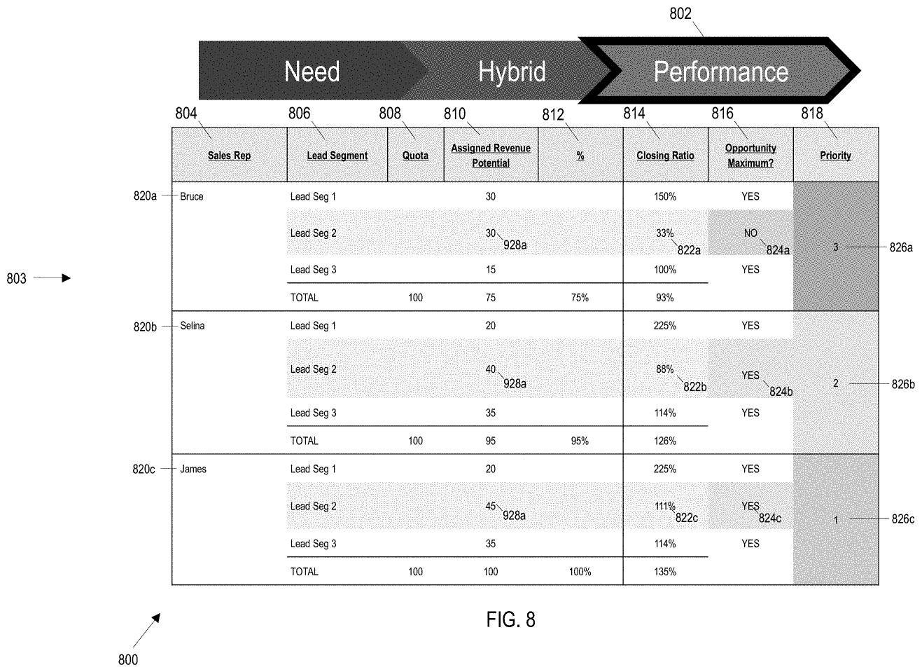

Turning to FIG. 8, shown is a process overview diagram 800 of a performance-based lead routing technique 802, in accordance with exemplary embodiments.

The process overview diagram 800 includes an example screen shot of an outcome of a performance-based lead routing process 802. The diagram can be displayed in a GUI generated by the present system. For example, the generated GUI can include HTML generated by the server computer of the present system. By way of example and not limitation, the diagram includes a table 803 with a column 804 labeled “Sales Rep” that lists names of three account resources Bruce, Selina, and James. The table also includes a column 806 labeled “Lead Segment” that shows each account resource being associated with three lead segments. The lead segments are labeled as Lead Seg 1, Lead Seg 2, and Lead Seg 3. The table also includes a column 808 labeled “Quota” that represents the lead quota associated with each account resource. The table also includes a column 810 labeled “Assigned Rev Potential” that represents the assigned revenue potential by lead segment for each account resource. The table also includes a column 812 labeled “%” that represents a percentage based on the assigned revenue potential relative to the lead quota associated with each account resource. The table also includes a column 814 labeled “Closing Ratio” that represents the closing ratio associated with each account resource. The table also includes a column 816 labeled “Opportunity Maximum?” that indicates whether the account resource has met an opportunity measure for new routed leads. Finally, the table includes a column 818 labeled “Priority” that represents the relative priority with which a received lead is to be routed to a particular account resource relative to another account resource.

The performance-based lead routing process (sometimes referred to herein as a performance-based distribution process) is configured to determine the account resource for receiving the routed lead based on determining a closing ratio for each account resource among the plurality of account resources determined based on the identified lead segment. In some aspects, the account resource is determined based on identifying the account resource having a maximum closing ratio among the plurality of account resources associated with the identified lead segment. In further aspects, the account resource is determined based on an opportunity measure. For example, the present system determines the closing ratio 814 for account resource 820a Bruce to be 150% for Lead Seg 1, 33% for Lead Seg 2, and 100% for Lead Seg 3; the closing ratio for account resource 820b Selina to be 225% for Lead Seg 1, 88% for Lead Seg 2, and 114% for Lead Seg 3; and the closing ratio for account resource 820c James to be 225% for Lead Seg 1, 111% for Lead Seg 2, and 114% for Lead Seg 3. Accordingly, for an incoming lead that the present system identifies is a match for Lead Seg 2, the present system determines based on the closing ratios for the identified lead segment that James should receive the incoming lead since James's closing ratio 822c for Lead Seg 2 is 111% versus a closing ratio 822a of 33% for Bruce and a closing ratio 822b of 88% for Selina. In some aspects, the present system further analyzes the opportunity measure for each account resource, for example by determining that James has not yet met his opportunity measure 816 for new leads since the “Opportunity Maximum?” field indicates “yes.” Accordingly, the present system determines that James should receive the highest priority 826c labeled as “1.” In contrast, account resource Selina is associated with a lower priority 826b labeled “2” and account resource Bruce is associated with a still lower priority 826a labeled “3.” As a result, the present system is configured to route a received lead to account resource James since the performance-based distribution process associates this account resource with the best performance in light of the identified lead segment for the received lead (e.g., Lead Seg 2), and in light of the corresponding opportunity measure (e.g., James has not met his opportunity maximum representing his weekly cap for new leads).

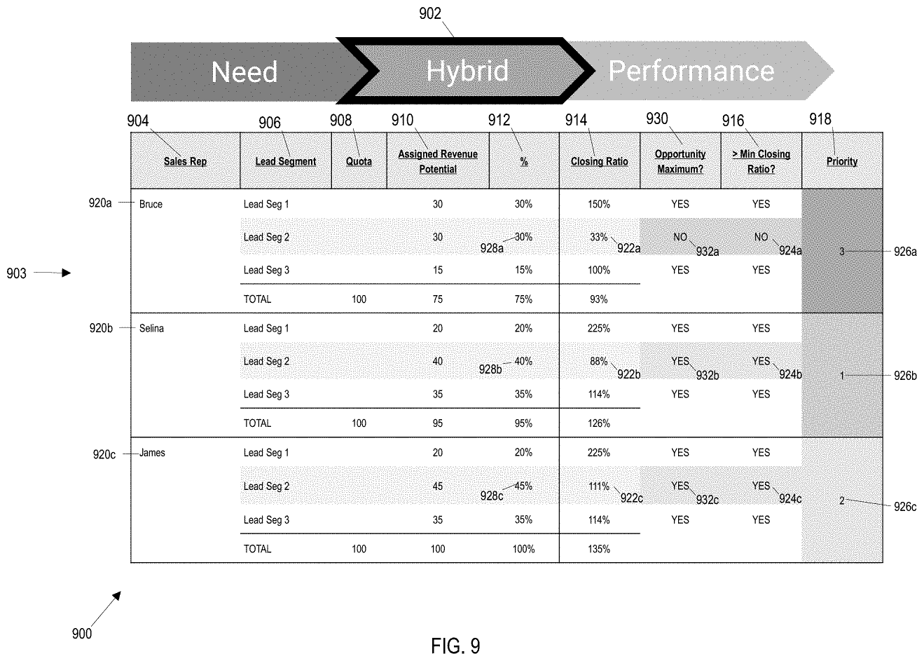

Turning to FIG. 9, shown is a process overview diagram 900 of a hybrid lead routing technique 902, in accordance with exemplary embodiments.

The process overview diagram 900 includes an example screen shot of an outcome of a hybrid lead routing process 902. The diagram can be displayed in a GUI generated by the present system. By way of example and not limitation, the diagram includes a table 903 with a column 904 labeled “Sales Rep” that lists names of three account resources listed as Bruce, Selina, and James. The table also includes a column 906 labeled “Lead Segment” that shows each account resource being associated with three lead segments. The lead segments are labeled as Lead Seg 1, Lead Seg 2, and Lead Seg 3. The table also includes a column 908 labeled “Quota” that represents the lead quota associated with each account resource. The table also includes a column 910 labeled “Assigned Rev Potential” that represents the assigned revenue potential by lead segment for each account resource. The table also includes a column 912 labeled “%” that represents an assigned revenue potential percentage relative to the lead quota associated with each account resource. The table also includes a column 914 labeled “Closing Ratio” that represents the closing ratio for each lead segment associated with each account resource. The table also includes a column 930 labeled “Opportunity Maximum?” that indicates whether the account resource has met a pre-determined opportunity measure for new routed leads. The table also includes a column 916 labeled “At/Above Min Closing Ratio?” that indicates whether the account is at or above the minimum closing ratio. Finally, the table includes a column 918 labeled “Priority” that represents the relative priority determined to be associated with a particular account resource such that that a received lead is to be routed to the particular account resource relative to another account resource.

The hybrid lead routing process (sometimes referred to herein as a hybrid distribution process) is configured to determine the account resource for receiving the routed lead based on a percentage of the assigned revenue potential relative to the lead quota, a closing ratio, and an opportunity measure. In some aspects, the opportunity measure includes an opportunity maximum, and the account resource is determined based on determining a lowest percentage of the assigned revenue potential while satisfying a minimum closing ratio and the opportunity maximum. For example, the present system determines the assigned revenue potential percentage 912 for account resource 920a Bruce to be 30% for Lead Seg 1, 30% for Lead Seg 2, and 15% for Lead Seg 3; the assigned revenue potential percentage for account resource 920b Selina to be 20% for Lead Seg 1, 40% for Lead Seg 2, and 35% for Lead Seg 3; and the assigned revenue potential percentage for account resource 920c James to be 20% for Lead Seg 1, 45% for Lead Seg 2, and 35% for Lead Seg 3. The present system also determines the closing ratio 914 for Bruce to be 150% for Lead Seg 1, 33% for Lead Seg 2, and 100% for Lead Seg 3; the closing ratio for Selina to be 225% for Lead Seg 1, 88% for Lead Seg 2, and 114% for Lead Seg 3; and the closing ratio for James to be 225% for Lead Seg 1, 111% for Lead Seg 2, and 114% for Lead Seg 3. Accordingly, for an incoming lead that the present system identifies is a match for Lead Seg 2, the present system determines based on the assigned revenue potential percentage, the closing ratio, and the opportunity measure that Selina should receive the incoming lead since Selina's percentage 928b of assigned revenue potential for Lead Seg 2 is 40% versus a percentage 928a of assigned revenue potential of 30% for Bruce and a percentage 928c of assigned revenue potential of 45% for James. In contrast, it is notable that, according to a need-based distribution method, Bruce would instead have been determined to be the account resource to receive the incoming lead because the corresponding assigned revenue potential percentage 928a indicates that Bruce has the highest need for an incoming lead. However, the hybrid distribution method further analyzes performance-based metrics including the closing ratio and the opportunity measure for each account resource. For example, based on the corresponding closing ratio 922b of 88% for Selina and the closing ratio 922c of 111% for James, the present system determines that Selina and James both meet a minimum closing ratio 916 since the minimum closing ratio fields 924b, 924c indicate “yes” for Selina and James, respectively. However, based on the corresponding closing ratio 922a of 33% for Bruce, the present system determines that Bruce fails to meet the minimum closing ratio since the minimum closing ratio field 924a indicates “no” for Bruce. The present system further analyzes an opportunity measure 930 for each account resource. For example, the present system determines that Selina and James have not yet met their opportunity measures 930 for new leads, since the “Opportunity Maximum?” fields 932b, 932c indicate “yes.” In contrast, Bruce has met his opportunity measure for new leads since the “Opportunity Maximum” field 932a indicates “no.” Accordingly, the present system determines that Selina receives the highest priority 926b labeled as “1.” In contrast, account resource James is associated with a lower priority 926c labeled “2” and account resource Bruce is associated with a still lower priority 926a labeled “3.” As a result, the present system is configured to route a received lead to account resource Selina since this account resource has the highest need (e.g., is furthest behind) compared to the other account resources that are meeting the performance-based minimum based on closing ratio and opportunity measure for received leads associated with the identified lead segment (e.g., Lead Seg 2).

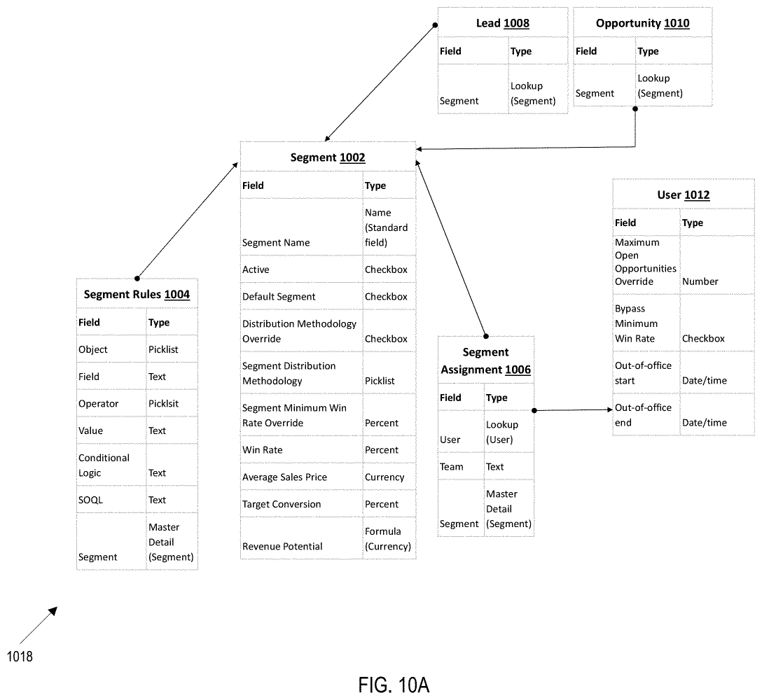

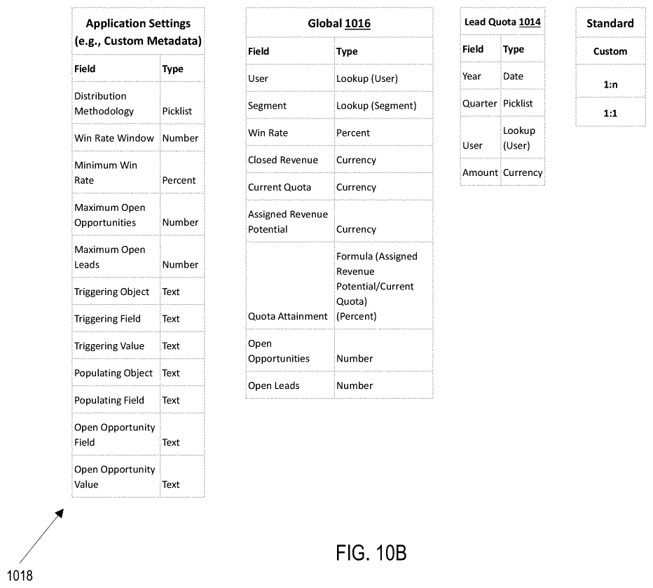

Referring now to FIGS. 10A-10B, shown are diagrams 1000, 1018 of data structures suitable for lead routing, in accordance with exemplary embodiments. For example, the diagrams 1000, 1018 illustrate data structures including records for use in a persistent store such as a database. The diagram 1000 includes a Segment record 1002 for storing lead segment records and fields such as assigned revenue potential and revenue potential. The Segment record is associated with Segment Rule records 1004 and Segment Assignment records 1006 for assigning lead records to the Segment record. The Lead record 1008 is associated with an Opportunity record 1010 that includes sales opportunity data. The diagram 1000 further includes a User record 1012 configured to store user data such as account resources to be associated with the Lead records. Referring to FIG. 10B, the diagram 1018 further includes a Lead Quota record 1014 configured to store lead-quota-related data. The diagram 1018 also includes a Global record 1016 configured to store lead assignment and routing factors such as a Distribution Methodology (e.g., a user selection of a need-based distribution method, a performance-based distribution method, or a hybrid distribution method).

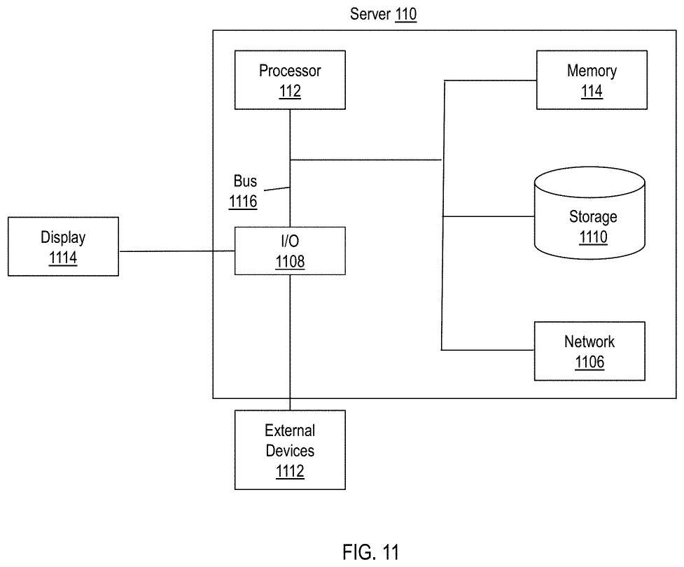

Referring now to FIG. 11, a block diagram is shown of an exemplary server computer 110 suitable for lead routing, in accordance with exemplary embodiments. The computer is shown in the form of a general-purpose computing device. Components of the computer may include, but are not limited to, one or more processors or processing units 112, a memory 114, a network interface 1106, and a bus 1116 that communicatively couples various system components including the system memory and the network interface to the processor.

The bus 1116 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 110 typically includes a variety of computer-readable media. Such media may be any available media that is accessible by the computer system, and such media includes both volatile and non-volatile media, removable and non-removable media.

The memory 114 may include computer system readable media in the form of volatile memory, such as random-access memory (RAM) and/or cache memory. The computer system may further include other removable/non-removable, volatile/non-volatile computer system storage media. By way of example only, the storage system 1110 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 1116 by one or more data media interfaces. As has been depicted and described above in connection with FIGS. 1-10, the memory may include at least one computer program product having a set (e.g., at least one) of program modules that are configured to carry out the functions of the embodiments as described herein, e.g., lead routing.

The computer 110 may also include a program/utility, having a set (at least one) of program modules, which may be stored in the memory 114 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 110 may also communicate with one or more external devices 1112 such as a keyboard, a pointing device, a display 1114, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 1108. Still yet, the computer system may communicate with one or more networks such as a local area network (LAN), a general wide area network (WAN), and/or a public network (e.g., the Internet) via the network adapter 1106. As depicted, the network adapter communicates with the other components of the computer system via the bus 1116. It should be understood that although not shown, other hardware and/or software components could be used in conjunction with the computer system. Non-limiting examples include microcode, device drivers, redundant processing units, external disk drive arrays, Redundant Array of Independent Disk (RAID) systems, tape drives, data archival storage systems, etc.

The routing of incoming leads to account resources can be challenging because the systems and methods disclosed herein can be configured to work with hundreds or thousands of applications, websites, leads, lead segments, prospective customers, account resources, and application administrators, each with hundreds or thousands of simultaneous web users. Therefore, the systems herein must be configured to process and manage thousands or millions of leads, lead segments, and account resources simultaneously. In exemplary embodiments, the present system can be configured to process received leads from various prospective customers once every 1 second, 2 seconds, 3 seconds, 4 seconds, 5 seconds, or more. The sheer volume of data coming into the present system makes it impossible for a human being, whether entirely in the person's mind or whether the person is using a pen and paper, to track and/or perform, in real-time or substantially real-time (for example, within 1 to 30 seconds, or within 1 second to 1 minute), the activities of the exemplary embodiments of the systems and methods disclosed herein. Similarly, it is impossible for a human being, whether entirely in the person's mind or whether the person is using a pen and paper, to process in real-time or substantially real time (for example, within 1 to 30 seconds) for hundreds or thousands of simultaneous incoming leads routing the received leads to account resources so as to maximize throughput and minimize latency of the present lead routing systems and methods.

The various exemplary embodiments discussed herein provide numerous advantages over conventional lead routing systems. For example, the present system is configured to determine a revenue potential associated with the lead so as to route incoming leads to appropriate account resources. In contrast, conventional lead routing systems apply inflexible business rules, count-based approaches, or weighting-based approaches that are not configured to account for a revenue potential associated with the lead.

Furthermore, the present system advantageously applies an assigned revenue potential for each account resource relative to a lead quota for each account resource so as to route incoming leads. For example, the present system can be configured to determine a percentage of assigned revenue potential for the account resource relative to the lead quota.

A further advantage is that the present system can modify routing the incoming leads so as to account for additional factors that may be pre-determined or provided by an application administrator, such as routing leads to higher performing account resources or avoiding account resources who may have conflicts (for example, being out of the office or away on vacation, holiday, leave, or the like).

“About” as used herein when referring to a measurable value such as an amount, a temporal duration, and the like, is meant to encompass variations of ±20%, ±10%, ±5%, ±1%, or ±0.1% from the specified value, as such variations are appropriate.

Throughout this disclosure, various aspects of the subject disclosure may have been presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the present disclosure may be practiced without one or more of the specific features or advantages of a particular exemplary embodiment. In other instances, additional features and advantages may be recognized in certain embodiments that may not be present in all exemplary embodiments of the subject disclosure.

It will be appreciated by those skilled in the art that changes could be made to the various aspects described above without departing from the broad inventive concept thereof. It is to be understood, therefore, that the subject application is not limited to the particular aspects disclosed, but it is intended to cover modifications within the spirit and scope of the subject application as defined by the appended claims.

What is claimed is:

1. A computer system for routing a lead to an account resource, the system comprising:
a memory configured to store leads, lead segments, and account resources; and
a processor communicatively coupled to the memory, the processor configured to:
identify a lead segment to assign a received lead based on an industry, geography, employee count, or persona for the lead, each lead segment including a plurality of leads,
determine a plurality of account resources based on the identified lead segment, each account resource having a lead quota, an assigned revenue potential, a closing ratio, and an opportunity measure, and
route the lead to an account resource from the plurality of account resources based on the lead quota, the assigned revenue potential, the closing ratio, or the opportunity measure determined for each account resource in the plurality of account resources.

2. The system of claim 1, wherein the processor configured to route the lead to the account resource is further configured to determine the account resource for receiving the routed lead based on determining a percentage of the assigned revenue potential relative to the lead quota.

3. The system of claim 2, wherein the account resource is determined based on comparing the percentages of the assigned revenue potential among the plurality of account resources, and identifying the account resource having the lowest percentage of assigned revenue potential to receive the routed lead.

4. The system of claim 1, wherein the processor configured to route the lead to the account resource is further configured to determine the account resource for receiving the routed lead based on the closing ratio for each account resource among the plurality of account resources determined based on the identified lead segment.

5. The system of claim 4, wherein the account resource is determined based on identifying the account resource having a maximum closing ratio among the plurality of account resources associated with the identified lead segment to receive the routed lead.

6. The system of claim 1, wherein the processor configured to route the lead to the account resource is further configured to determine the account resource for receiving the routed lead based on the closing ratio, the opportunity measure, and a percentage of the assigned revenue potential determined relative to the lead quota.

7. The system of claim 6, wherein the opportunity measure comprises an opportunity maximum, and wherein the account resource is determined based on comparing the percentages of assigned revenue potential among the plurality of account resources, and identifying the account resource having a lowest percentage of assigned revenue potential while satisfying a minimum closing ratio and the opportunity maximum to receive the routed lead.

8. The system of claim 1, wherein the received lead has a revenue potential.

9. The system of claim 1, wherein the lead quota is determined based on a revenue target associated with the account resource to be achieved in a predetermined time period.

10. A computer-implemented method of routing a lead to an account resource, the method comprising:
identifying, using a computer, a lead segment to assign a received lead based on an industry, geography, employee count, or persona for the lead, each lead segment including a plurality of leads;
determining, using the computer, a plurality of account resources based on the identified lead segment, each account resource having a lead quota, an assigned revenue potential, a closing ratio, and an opportunity measure; and
routing, using the computer, the lead to an account resource from the plurality of account resources based on the lead quota, the assigned revenue potential, the closing ratio, or the opportunity measure determined for each account resource in the plurality of account resources.

11. The method of claim 10, wherein the routing the lead to the account resource further comprises determining the account resource for receiving the routed lead based on determining a percentage of the assigned revenue potential relative to the lead quota.

12. The method of claim 10, wherein the routing the lead to the account resource further comprises determining the account resource for receiving the routed lead based on the closing ratio for each account resource among the plurality of account resources determined based on the identified lead segment.

13. The method of claim 10, wherein the routing the lead to the account resource further comprises determining the account resource for receiving the routed lead based on the closing ratio, the opportunity measure, and a percentage of the assigned revenue potential determined relative to the lead quota.

14. The method of claim 10, wherein the closing ratio is determined based on a count of leads routed to an account resource relative to a count of leads closed by the account resource.

15. The method of claim 14, wherein the closing ratio is further determined based on a predetermined time window.

16. A non-transitory computer-readable medium having instructions stored therein which upon execution cause a processor to:
identify a lead segment to assign a received lead based on an industry, geography, employee count, or persona for the lead, each lead segment including a plurality of leads;
determine a plurality of account resources based on the identified lead segment, each account resource having a lead quota, an assigned revenue potential, a closing ratio, and an opportunity measure; and
route the lead to an account resource from the plurality of account resources based on the lead quota, the assigned revenue potential, the closing ratio, or the opportunity measure determined for each account resource in the plurality of account resources.

17. The computer-readable medium of claim 16, wherein the instructions which upon execution cause the processor to route the lead to the account resource further comprise instructions which upon execution cause the processor to determine the account resource for receiving the routed lead based on determining a percentage of the assigned revenue potential relative to the lead quota.

18. The computer-readable medium of claim 16, wherein the instructions which upon execution cause the processor to route the lead to the account resource further comprise instructions which upon execution cause the processor to determine the account resource for receiving the routed lead based on the closing ratio for each account resource among the plurality of account resources determined based on the identified lead segment.

19. The computer-readable medium of claim 16, wherein the instructions which upon execution cause the processor to route the lead to the account resource further comprise instructions which upon execution cause the processor to determine the account resource for receiving the routed lead based on the closing ratio, the opportunity measure, and a percentage of the assigned revenue potential determined relative to the lead quota.

20. The computer-readable medium of claim 16, wherein the lead has a revenue potential, a win rate, an average sales price, and a target conversion rate, and wherein the revenue potential is determined based on multiplying the win rate by the average sales price and by the target conversion rate.

21. The computer-readable medium of claim 20, wherein the win rate is determined based on determining a likelihood of winning an opportunity after the opportunity has been qualified, wherein the opportunity is based on a lead after the lead has been qualified, and wherein the lead is qualified by an account resource based on a determination of a likelihood of the lead generating revenue if the lead is pursued.

22. The computer-readable medium of claim 20, wherein the average sales price is determined based on the lead or the identified lead segment.

23. The computer-readable medium of claim 20, wherein the target conversion rate is determined based on a likelihood of qualifying the lead into an opportunity to generate revenue.
